(19) United States
(12) Patent Application Publication
(10) Pub. No.: US 2025/0392534 A1
(43) Pub. Date: Dec. 25, 2025

(54) SYSTEM FOR TRANSMITTING DATA OVER A MEDIUM WHICH IS SHARED BY SEVERAL COMMUNICATION PARTICIPANTS THROUGH TIME-DIVISION MULTIPLEXING

(71) Applicant: WAGO Verwaltungsgesellschaft mbH, Minden (DE)

(72) Inventor: Markus WEIDNER, Minden (DE)

(73) Assignee: WAGO Verwaltungsgesellschaft mbH, Minden (DE)

(21) Appl. No.: 19/249,164

(22) Filed: Jun. 25, 2025

(30) Foreign Application Priority Data
Jun. 25, 2024 (DE) 10 2024 117 883.3

(51) Int. Cl. H04L 43/10; G06F 1/04

(52) U.S. Cl. CPC H04L 43/10; G06F 1/04

(57) ABSTRACT

A system is provided for transmitting data over a medium shared by several communication participants through time-division multiplexing comprising a communication participant and a monitoring module. The communication participant is configured to output first signals which are intended to be transmitted over the medium and to read second signals transmitted over the medium, and the monitoring module is configured to read the first signals and the second signals and to decide, on the basis of the read first and second signals. A transmission of data by the communication participant over the medium is to be, at least temporarily, suspended

This nonprovisional application claims priority under 35 U.S.C. § 119(a) to German Patent Application No. 10 2024 117 883.3, which was filed in Germany on Jun. 25, 2024, and which is herein incorporated by reference.

### BACKGROUND OF THE INVENTION

### Field of the Invention

The present invention relates to a system for transmitting data over a medium which is shared by several communication participants through time-division multiplexing. In particular, the present invention relates to a monitoring module which is configured to decide whether a transmission of data by one of the communication participants over the medium is to be, at least temporarily, suspended.

### Description of the Background Art

In a communication system to which several communication participants are connected in such a way that they share a common communication medium and the communication is organized by time-division multiplexing, the use of the transmission capacity can often be improved by ensuring that participants accessing the medium cause no, or as few as possible, collisions. Accordingly, it is generally advantageous if the transmission behavior of the communication participants is controlled in accordance with a conflict avoidance or conflict resolution procedure that is observed by all communication participants.

However, observing a conflict avoidance or conflict resolution procedure may not be sufficient in all cases. Rather, it may be advantageous to ensure that communication participants do not take part in the communication with incorrect messages or with messages at the wrong time but adhere to an application-specific communication plan.

Whereas violations of a conflict avoidance or conflict resolution procedure that must be observed may be caused by random errors, such as component failures, and manifest themselves in random behavior of the communication participant, a violation of the application-specific communication plan may occur despite compliance with the conflict avoidance or conflict resolution procedure, e.g. if a communication participant is compromised and the deviations caused by this are of a systematic nature, since a compromised communication participant can be made to behave in a way that is compliant with the communication protocol used (which includes the conflict avoidance or conflict resolution procedure), but not in a way that is compliant with the communication plan.

### SUMMARY OF THE INVENTION

It is therefore an object of the invention to minimize the disruptive influence of a faulty communication participant on the communication of all other communication participants, taking into account not only errors regarding the observance of the communication protocol but also behavioral errors manifesting themselves at a higher level.

In an example, a system is provided for transmitting data over a medium shared by several communication participants through time-division multiplexing may comprise a communication participant and a monitoring module, wherein the communication participant may be configured to output first signals which are intended to be transmitted over the medium and to read second signals transmitted over the medium, and the monitoring module may be configured to read the first signals and the second signals and to decide, on the basis of the read first and second signals, whether a transmission of data by the communication participant over the medium is to be, at least temporarily, suspended

In this regard, the term “communication participant”, may refer to an electronic circuit with a processor and a memory, which is assigned a unique sending and/or receiving address and which provides messages to be sent over the medium with the sending address and processes messages received over the medium if these are addressed to the receiving address, where the sending and receiving addresses may be the same, or which is assigned one or more sending message identifiers and which provides messages to be sent over the medium with one of these sending message identifiers and processes messages received over the medium if they have a specific receiving message identifier.

Furthermore, the term “medium” may refer to a wire or an optical fiber. In this context, the term “signals” may refer to electrical or optical signals. Moreover, the term “module” may refer to a circuit arranged in a housing, wherein the input and output of signals is effectuated via pins which may extend outwards from the circuit through recesses in the housing and may be in contact, at their distal end, with structures arranged on a printed circuit board (or other supporting structure).

The system may further comprise a communication module, wherein the communication module may be configured to forward the first signals to the medium and the second signals to the communication participant and the monitoring module. The communication module may, for example, be a transceiver.

The communication module may comprise a control input which is to be connected to a control output of the monitoring module, and the communication module may be configured to prevent the forwarding of the first signals depending on a control signal applied to the control input.

This may prevent the communication participant from transmitting data over the medium, even if the communication participant is compromised and therefore outputs signals to the communication module that are protocol-compliant but violate the application-specific communication plan.

The monitoring module may be further configured to check the first signals and the second signals to determine whether the communication participant is outputting the first signals in accordance with a set of rules that regulate access of the communication participants to the medium, and to at least temporarily suspend the transmission of data by the communication participant over the medium if the check reveals that the communication participant is violating one of the rules.

The monitoring module may be further configured to derive, from the first and second signals and a set of rules by which the access of the communication participants to the medium is regulated, when the transmission of data by the communication participant is permitted, and to block the transmission of data by the communication participant over the medium when the transmission of data by the communication participant is not permitted.

The monitoring module may comprise a memory configured to store a communication plan. The monitoring module may be configured to derive from the communication plan when the communication module may transmit messages of a specific message type or messages with a specific content over the medium.

The communication plan may divide the communication participants into different groups and require that the data transmitted by communication participants from the same group over the medium have a specific relationship with one another.

For example, the communication plan may stipulate that several or all members of a group send their data one after the other within a specified period of time. To this end, it may be necessary to determine from the messages whether they are related to each other. This may be achieved, for example, by including the identity of the respective communication participant and/or a message identifier in the messages.

Furthermore, the monitoring module may be configured to detect an erroneous message by the fact that a relationship to other messages can be derived from the message, but these other messages were not sent by the other communication participants or were not sent within a defined period of time. From this, the monitoring module may conclude that the majority of the concerned communication participants have decided that this is not the right time to send the messages.

Conversely, the majority of members of a group may send messages within a specified period of time, and the monitoring module may determine from one or more of the members not sending messages that the members are not functioning properly. The determination may, for example, be realized by the monitoring module being aware of the identity of the communication participant to which the monitoring module is assigned and expecting this participant to take part in the group's message output with a message. In other words, the monitoring modules may recognize the correct period for sending by the majority of group members outputting their related messages within a period of time.

The monitoring module may be further configured to derive the communication plan from the second signals. For example, the monitoring module may monitor the communication taking place during a learning phase and derive the communication plan from the information collected during the monitoring.

The monitoring module may comprise a clock generator or a clock input which is to be connected to an external clock generator. The monitoring module may be further configured to derive symbols from the first and/or second signals taking into account the clock of the clock generator.

The monitoring module may be further configured to derive a transmission clock from the first and/or second signals and to derive symbols from the first and/or second signals taking into account the transmission clock.

The monitoring module may be further configured to derive identities of the communication participants or message identifiers from the symbols.

The monitoring module may be further configured to monitor whether the data correctly reflects the identity of the communication participant or a message identifier assigned to the communication participant for use, and to at least temporarily suspend the transmission of further data by the communication participant over the medium if the data does not correctly reflect the identity of the communication participant or the message identifier assigned to the communication participant for use.

The monitoring module may comprise a configuration interface which is configured not to be accessible to the communication participant during operation of the monitoring module.

Furthermore, it is noted that the features described with reference to the system may also be features of the method in which the system may be used and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically illustrates several communication participants transmitting data over a shared medium;

FIG. 2 shows a block diagram of a communication participant, a communication module, and a monitoring module;

FIG. 3 illustrates first exemplary rules to be followed by the communication participants when communicating over the shared medium;

FIG. 4 illustrates second exemplary rules to be followed by the communication participants when communicating over the shared medium; and

FIG. 5 shows a flowchart of a method for transmitting data by multiple communication participants over a shared medium.

### DETAILED DESCRIPTION

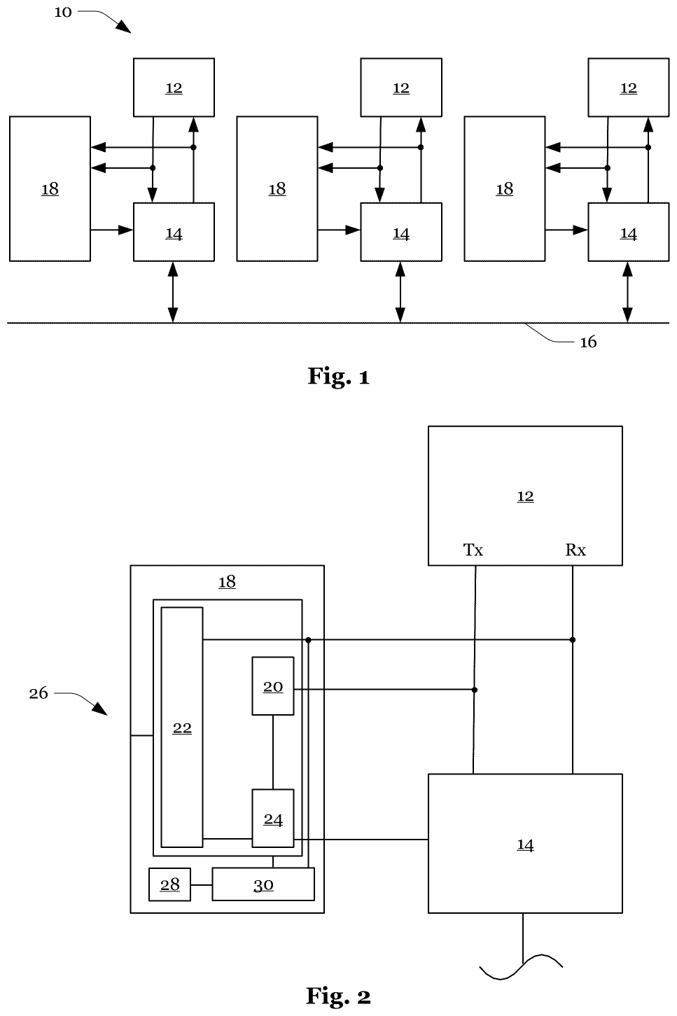

FIG. 1 shows a schematic representation of a data bus 10 comprising several communication participants 12. Each of the communication participants 12 is connected to a communication module 14 (e.g. a transceiver) via two unidirectionally operated communication lines. Each of the communication modules 14 feeds the signals intended for transmission over the medium 16 into the latter and makes the sum signal, which is formed by all signals fed into the medium 16, available to the respective communication participant 12. Each of the communication participants 12 is also assigned a monitoring module 18. Each of the monitoring modules 18 monitors the activity of a specific communication participant 12 by reading the transmission signal that this communication participant 12 outputs to the communication module 14 for feeding into the medium 16.

In addition, the monitoring module 18 reads the sum signal which the communication module 14 makes available to the monitoring module 18. The monitoring module 18 analyzes the communication and has the option of excluding the communication participant 12 from the communication by blocking or not enabling the feeding of signals into the medium 16 by the communication module 14. However, the monitoring module 18 is not itself capable of participating in the data traffic over the medium 16 or of influencing the data traffic over the medium 16 by initiating the generation of messages by third parties or by modifying messages. A failure of a monitoring module 18 therefore leads at most to the communication participant 12 to which the monitoring module 18 is assigned being prevented from participating in the communication, but not to the entire communication traffic being disrupted.

FIG. 2 shows a block diagram of a communication participant 12, a communication module 14 and a monitoring module 18 according to an embodiment. The monitoring module 18 comprises a subscriber analysis circuit 20 through which the transmission signal Tx, which the communication participant 12 outputs to the medium 16, is analyzed. As part of the transmission signal analysis, the participant analysis circuit 20 interprets the symbol stream output by the communication participant 12 and may thus detect whether the participant 12 always sends messages under the same identification and, in particular, under the identification assigned to it.

The monitoring module 18 further comprises a communication analysis circuit 22 which analyzes the sum signal. Based on the sum signal analysis, the monitoring module 18 may adapt to the communication protocol and observe the message exchange between the communication participants 12. The results of the analyses may then be fed to a rule and access control circuit 24, which checks the communication activity of the communication participant 12 against an implemented rule set and, depending on the result of the check, blocks or enables the output of symbols of the communication participant 12 to the medium 16 by outputting a corresponding signal to an input of the communication module 14.

The monitoring module 18 may also include a configuration interface 26, via which the set of rules or characteristics of the set of rules may be specified. The set of rules may, for example, specify or restrict the communication options of the communication participant 12 with regard to the frequency with which data is transmitted over the medium 16 or the priority that is or can be assigned to the data. Furthermore, an identity (possibly expressed by an identification value) may be configured with which the communication participant 12 labels the data which is to be transmitted over the medium 16.

The configuration interface 26 of the monitoring module 18 is isolated from the communication participants 12 and the medium 16, so that the configuration cannot be changed by the communication participants 12 or by means of communication via the medium 16. In addition, the configuration interface 26 may be designed in such a way that it is only accessible via special tools and/or during commissioning of the monitoring module 18. Furthermore, the monitoring module 18 may also be isolated from the communication participants 12 and the medium 16 with regard to the further interfaces of the monitoring module 18 in that the behavior of the monitoring module 18 cannot be changed or manipulated via the interfaces through which the monitoring module 18 is connected to the communication participant 12 and the medium 16.

Participant analysis circuit 20, communication analysis circuit 22, and rule and access control circuit 24 may be replaced by a microcontroller on which the functionality of the circuits is implemented by software. Changes in the behavior of the monitoring module 18 may then be achieved by changing the implementation, for example by a software update, or by changing the configuration.

In this regard, it may be envisaged that the software does not require a configuration and that the implementation cannot be changed via the interfaces through which the monitoring module 18 is connected to the communication participant 12 and the medium 16 (and is therefore protected). If a configuration is required, it may be obtained from an isolated source that cannot be manipulated by the communication participants 12 or over the medium 16. For example, the configuration interface 26 may be used for this purpose. Furthermore, it is possible to implement a special protocol in the software with which the communication participant 12 can change the implementation, the rules, or the configuration of the monitoring module 18 through the transmission signal Tx. In this case, there may be authorization protection with a password.

The monitoring module 18 may further comprise its own clock generator 28 and a synchronization circuit 30 which enables the monitoring module 18 to synchronize itself based on the sum signal Rx to a symbol sequence transmitted over the medium 16. Although the provision of a separate clock generator 28 may improve the isolation of the monitoring module 18, the system clock may instead be derived from the sum signal Rx.

Using the transmission signal Tx and the sum signal Rx, the monitoring module 18 may be able to analyze the communication traffic just as completely as the communication participant 12. Thus, the monitoring module 18 may be enabled to check the behavior of the communication participant 12 against the rules and, based on the result of the check, block or enable the output of symbols to the medium 16 by the communication participant 12. Blocking symbol output may serve, inter alia, the following purposes:

Blocking may be carried out preventively if, according to the protocol specification, the communication participant 12 is not authorized to transmit during an upcoming period. Accordingly, the output may be blocked because if it were to take place by mistake, it would disrupt the communication on the medium 16.

Furthermore, rule violations (which cannot be preemptively ruled out) that have already led to a disruption of communication traffic may also be detected. In this case, a temporary or permanent suspension may be imposed curatively to prevent further disruptions.

A suspension (by blocking the communication channel implemented by the communication module 14) as a result of a rule violation that has already occurred cannot retroactively prevent the disruption. However, the suspension may be enforced permanently or temporarily by the monitoring module 18 and thereby limit the extent of possible disruptions per time period that may be caused by the communication participant 12. This relative amount of disruption may then be taken into account in a communication plan in such a way that a corresponding transmission capacity may be planned as a reserve, so that a permanent disruption of one or all communication participants 12 cannot lead to an overload situation with regard to the medium 16.

On the one hand, the symbol output may be blocked if the communication participant 12 has not been assigned the exclusive transmission right for the upcoming period as a result of the conflict resolution. In order for the monitoring module 18 to be able to detect whether this is the case, it may analyze the symbol sequence output by the communication participant 12 during conflict resolution and compare it with the sum signal Rx on the medium 16. From this, the monitoring module 18, just like the communication participant 12 itself, may be able to recognize whether the communication participant 12 is authorized to transmit in an upcoming period or not.

On the other hand, both the communication participant 12 and the monitoring module 18 may be provided with the same identification value and the monitoring module 18 may check during message output whether the communication participant 12 presents itself on the medium 12 with its correct identity. If this is not the case, the monitoring module 18 may impose a suspension.

Furthermore, the monitoring module 18 may prevent a communication participant 12 from sending messages at (the wrong) times, which are protocol-compliant but which, due to their occurrence, place a strain on the transmission capacity. The communication protocol may be adapted to this end, wherein the communication participants 12 may be logically grouped and their membership of a group may be indicated by their participant identification. In the communication plan, cyclically scheduled messages from the groups may then be brought into a fixed temporal relationship with one another. In addition, messages that relate to, or are in relationship with, messages from other group members may be marked using the message identification. The message identification may indicate, among other things, how many messages are related to each other.

Since the monitoring module 18 may read the sum signal Rx, it may be able to check whether the communication participant 12 sends messages at the right times or in the right time periods. To do so, the monitoring module 18 may first analyze the output identifications of the communication participant 12 and its message during the message output of the communication participant 12. From this information, the communication participant 12 may derive the expected behavior of other communication participants 12 in the group. The communication participant 12 may then compare the output with the outputs of other group members in terms of time period and number of messages due to the existing relations. The message outputs of the communication participants 12 may be interpreted as mutual confirmation of correctness. For example, if a communication participant 12 outputs a message at a certain time and this message is not confirmed by the message output of another group member within a specified time period, this may be interpreted as an error. By combining more than two communication participants 12 into a group, the monitoring module 18 may also be enabled to base its decision to suspend on a majority decision.

The combining of communication participants 12 and their messages may be particularly advantageous in systems with redundant safety-related channels. To this end, several communication participants 12 may carry out the same tasks in parallel and consequently send the same messages at the same time. These messages may then be related to each other and analyzed. In this way, it may be possible to verify the compliance with a concrete application-specific communication plan without having to explicitly configure the monitoring module 18 with it, which may improve the desired isolation. With regard to information security, the intentional falsification of the communication behavior of one communication participant 12 may require that several other communication participants 12 must also be changed at the same time so that the monitoring modules 18 recognize the overall behavior again as correct.

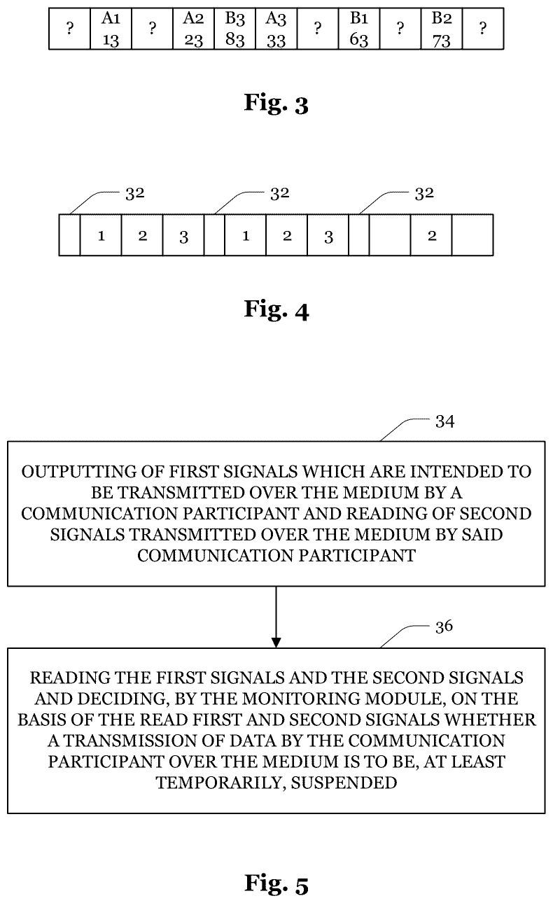

FIG. 3 illustrates a transmission of data over the medium 16 by six communication participants 12 which are assigned to two groups (A and B). Group A includes members A1, A2, and A3 and sends messages 13, 23, and 33. Group B includes members B1, B2, and B3 and sends messages 63, 73, and 83. The first digit (1, 2, 3, 6, 7, 8) indicates the identification of the actual message, and the second digit (3) indicates that they belong to a group of three messages. There are also other communication participants 12, the messages of which are marked with a question mark.

Each monitoring module 18 may check compliance with the following two exemplary rules. (1) Each communication participant 12 must represent itself on the medium 16 with the identity also provided to its monitoring module 18. (2) Messages marked as belonging to a group must be sent in ascending order and within 5 time units. Since the messages were output, none of the monitoring modules 18 detected a violation of the first rule, as otherwise the output would have been prevented. Accordingly, all communication participants 12 have identified themselves with the correct identity. For the participants in Group A, the monitoring modules 18 do not detect any violation of the second rule. However, the monitoring modules 18 of group B determine that both the order of the messages and the period in which the messages are output are not in compliance with the rules. By majority vote, they identify participant B3 as the cause of the disruption and suspend him.

FIG. 4 illustrates a transmission of data over the medium 16, wherein the conflict resolution 32 is such that the exclusive transmission right is not assigned to a single communication participant 12, but instead to a group of three communication participants 12. In the period following the conflict resolution 32, the group members are to output messages one after the other in a specified order. The period is divided into three sub-periods in which the members must output their messages. In the third period, a communication participant 12 was assigned the sending right for his group in the conflict resolution 32 and did output its message as member 2 of the group. However, members 1 and 3 of the group did not send anything. The monitoring module 18 of member 2 may thus determine that member 2 participated in the conflict resolution at the wrong time because the output of the message was not confirmed by the output of other messages from the group members.

FIG. 5 shows a flowchart of a method for transmitting data by the communication participants 12 over the shared medium 16. The method begins at step 34 with the output of first signals which are intended to be transmitted over the medium 16 by one of the communication participants 12 and the reading of second signals transmitted over the medium 16 by said communication participant 12. The method ends at step 36 with reading the first signals and the second signals and deciding, by the monitoring module 18, on the basis of the read first and second signals whether a transmission of data by the communication participant 12 over the medium 16 is to be, at least temporarily, suspended.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A system for transmitting data over a medium that is shared by at least two communication participants through time-division multiplexing, the system comprising:
a communication participant configured to output first signals which are intended to be transmitted over the medium and to read second signals transmitted over the medium; and
a monitoring module configured to read the first signals and the second signals and to decide on the basis of the read first and second signals whether a transmission of data by the communication participant over the medium is to be, at least temporarily, suspended.

2. The system according to claim 1, further comprising:
a communication module configured to forward the first signals to the medium and the second signals to the communication participant and the monitoring module.

3. The system according to claim 2, wherein the communication module comprises a control input which is to be connected to a control output of the monitoring module, and wherein the communication module is further configured to prevent the forwarding of the first signals depending on a control signal applied to the control input.

4. The system according to claim 3, wherein the monitoring module is further configured to check the first signals and the second signals to determine whether the communication participant is outputting the first signals in accordance with a set of rules that regulate access of the communication participants to the medium, and to at least temporarily suspend the transmission of data by the communication participant over the medium if the check reveals that the communication participant is violating one of the rules.

5. The system according to claim 3, wherein the monitoring module is further configured to derive, from the first and second signals and a set of rules by which the access of the communication participants to the medium is regulated, when the transmission of data by the communication participant is permitted, and to block the transmission of data by the communication participant over the medium when the transmission of data by the communication participant is not permitted.

6. The system according to claim 1, wherein the monitoring module comprises a memory configured to store a communication plan, and the monitoring module is further configured to derive from the communication plan when the communication module transmits messages of a specific message type or messages with a specific content over the medium.

7. The system according to claim 6, wherein the communication plan divides the communication participants into different groups and requires that the data transmitted by communication participants from the same group over the medium have a specific relationship to one another.

8. The system according to claim 6, wherein the monitoring module is further configured to derive the communication plan from the second signals.

9. The system according to claim 1, wherein the monitoring module comprises a clock generator or a clock input which is to be connected to an external clock generator, and wherein the monitoring module is further configured to derive symbols from the first and/or second signals taking into account the clock of the clock generator.

10. The system according to claim 1, wherein the monitoring module is further configured to derive a transmission clock from the first and/or second signals and to derive symbols from the first and/or second signals taking into account the transmission clock.

11. The system according to claim 9, wherein the monitoring module is further configured to derive identities of the communication participants or message identifiers from the symbols.

12. The system according to claim 11, wherein the monitoring module is further configured to monitor whether the data correctly reflects the identity of the communication participant or a message identifier assigned to the communication participant for use, and to at least temporarily suspend the transmission of further data by the communication participant over the medium if the data does not correctly reflect the identity of the communication participant or the message identifier assigned to the communication participant for use.

13. The system according to claim 2, wherein the monitoring module comprises a configuration interface which is configured not to be accessible to the communication participant during operation of the monitoring module.
